(19) United States
(12) Patent Application Publication
(10) Pub. No.: US 2024/0363950 A1
(43) Pub. Date: Oct. 31, 2024

(54) BATTERY CASE

(71) Applicant: HONDA MOTOR CO., LTD., Tokyo (JP)

(72) Inventors: Kazuki OHNO, Saitama (JP); Fumiyoshi KAMBARA, Saitama (JP)

(21) Appl. No.: 18/307,116

(22) Filed: Apr. 26, 2023

(51) Int. Cl. H01M 50/291; H01M 50/209; H01M 50/256

(52) U.S. Cl. CPC H01M 50/291; H01M 50/209; H01M 50/256; B60L 53/80; B60L 2200/32

(57) ABSTRACT

The battery case, comprising a case assembly (3, 9, 10) defining a front battery receiving portion (27F) and a rear battery receiving portion (27R) positioned one behind another in a longitudinal direction, and a fixing device (15) configured to selectively retain the batteries in the respective battery receiving portions, the fixing device including handle bars (44) extending across upper ends of the batteries received in the respective battery receiving portions, wherein the case assembly is provided with a sloping surface (50, 51) extending between the two battery receiving portions and sloping downward from the front battery receiving portion to the rear battery receiving portion, an extension of the sloping surface passing above the handle bar for the front battery receiving portion.

### TECHNICAL FIELD

The present invention relates to a battery case, and in particular to a battery case that can accommodate a plurality of batteries without requiring any undue effort when placing batteries into and out of the battery case.

### BACKGROUND ART

In recent years, efforts to realize a low-carbon society or a decarbonized society have been intensified, and research and development efforts are being directed to reducing CO2 emissions and improving energy efficiency in mobility devices as well. Mobility devices are often powered by electricity, and provided with a battery case for accommodating batteries therein to serve as a power source. Such a battery case is required to be protected from the elements, and configured such that the user can place the batteries into and out of the battery case with ease.

In most mobility devices, the available space is often so limited that the battery may not be positioned in the most convenient location and orientation. Therefore, the batteries may have to be positioned one behind the other, and the user is required to access the batteries from a front or rear end of the battery case. In such a case, the user may have difficulty in moving the batteries, in particular in moving the one on the far end of the battery case into and out of the battery case.

### SUMMARY OF THE INVENTION

In view of such a problem of the prior art, a primary object of the present invention is to provide a battery case that can be freely positioned in a mobility device or the like without causing any undue effort on the part of the user who install and remove batteries into and out of the battery case.

To achieve such an object, a certain aspect of the present invention provides a battery case (1), comprising: a case assembly (3, 9, 10) defining a front battery receiving portion (27F) and a rear battery receiving portion (27R) positioned one behind another in a longitudinal direction and each configured to receive a battery therein, each battery receiving portion having an upper opening (24) for passing the battery into and out of the battery receiving portion; and a fixing device (15) configured to selectively retain the batteries in the respective battery receiving portions, the fixing device including blocking parts (44) extending across upper ends of the batteries received in the respective battery receiving portions, wherein the case assembly is provided with a sloping surface (53) extending between the two battery receiving portions and sloping downward from the front battery receiving portion to the rear battery receiving portion, an extension (53E) of the sloping surface passing above the blocking part for the front battery receiving portion.

The sloping surface allows the battery to rest thereon so that the effort required for the user to move the battery into and out of the rear battery receiving portion can be minimized. In particular, the blocking part of the front battery receiving portion is prevented from interfering with the movement of the battery into and out of the rear battery receiving portion. The blocking part may be a retaining member that holds the battery in place, or a handle for operating such a retaining member.

Preferably, in this battery case, the sloping surface includes a front part (53) and a rear part (54), the rear part being steeper than the front part in inclination.

Thereby, when the battery is about to be placed in the battery receiving portion, the battery is initially supported by the front part of the sloping surface in a stable manner without imposing any undue strain on the user, and, once pushed over to the rear part of the sloping surface, is then allowed to drop into the rear battery receiving portion under the gravitational force without imposing any undue strain on the user. When removing the battery from the battery receiving portion, the battery is initially pulled up onto the rear part of the sloping surface without imposing any undue strain on the user. The user is then able to pull the battery onto the front part of the sloping surface again without imposing any undue strain on the user. Once the battery is pulled rearward along the front part of the sloping surface, the user is able to easily move the battery away from the battery case.

Preferably, in this battery case, the sloping surface is provided with a plurality of ribs (58) extending in the longitudinal direction.

The ribs are effective in reducing the friction between the battery and the sloping surface so that the battery can be placed into and out of the rear battery receiving portion with ease.

Preferably, in this battery case, a part of the case assembly on a front edge of the front battery receiving portion is provided with an additional sloping surface (51) sloping downward from a front part thereof to a rear part thereof.

Thereby, placing the battery into and out of the front battery receiving portion is facilitated.

Preferably, in this battery case, a part of the case assembly on a rear edge of the rear battery receiving portion is provided with a yet additional sloping surface (55) sloping upward from a front part thereof to a rear part thereof.

Thereby, when placing the battery in the rear battery receiving portion, even if the bottom end or the front end of the battery strikes upon the rear edge of the rear battery receiving portion, the battery can be favorably guided downward into the battery receiving portion.

Preferably, in this battery case, the yet additional sloping surface is provided with a plurality of ribs (59) extending in the longitudinal direction.

The ribs increase the mechanical strength and stiffness of the part of the case assembly on the rear edge of the rear battery receiving portion. In this regard, it is preferable that the ribs on the rear edge of the rear battery receiving portion are taller than the ribs on the front edge of the rear battery receiving portion.

Preferably, in this battery case, the front and rear battery receiving portions are configured to receive the batteries in a forwardly tilted attitude.

Thereby, the effort required to place the battery into and out of the front and rear battery receiving portions can be minimized.

Preferably, in this battery case, a rear part of a bottom end of each battery receiving portion is fitted with an electric connector (48).

Owing to the forward inclination of the front and rear battery receiving portions, the electric connectors are positioned above the lowest points of the front and rear battery receiving portions so that the electric connectors are protected from water even if water should get into the bottom end of the battery case.

Preferably, in this battery case, the blocking parts include a handle bar (44) extending across an upper end of the battery received in each battery receiving portion.

The handle bar is useful for operating the fixing device and/or effective in retaining the battery in the corresponding battery receiving portion, and the advantageous configuration of the sloping surface prevents the battery from being interfered by the handle bar when the battery is being placed into or out of the battery receiving portion.

Preferably, in this battery case, the handle bar is configured to extend across the upper end of the battery in a lock position of the fixing device, and tilt upward away from the upper end of the battery in an unlock position of the fixing device.

Thereby, the handle bar is particularly effective in retaining the battery in the corresponding battery receiving portion, and can be moved away from the upper opening of the battery receiving portion in a convenient manner when moving the battery into and out of the battery receiving portion.

Preferably, in this battery case, the case assembly includes an outer case (3) having an open top, a pair of inner cases (9) having open tops and received in the outer case to define the front and rear battery receiving portions therein, respectively, and an upper case (10) positioned on top of the inner cases and the outer case, and defining the upper openings for providing access to the battery receiving portions.

Thereby, the battery receiving portions can be defined by using a relatively simple structure. An article such as a circuit board or an electric component can be in the space defined between the inner case and the outer case, and the upper case closes this space from above. The access to the article can be gained by removing a removable lid of an opening provided in the upper case or removing the upper case.

Preferably, in this battery case, the upper case includes an upper case main body (10A) and a peripheral cover (10B) that is positioned on top of a peripheral part of the upper case main body of the upper case, the upper case main body being provided with the upper opening to allow access into each inner case, the upper case main body being fitted with a flap door (11) for each of the openings thereof which is pivotable between an upper closed position and a lower open position, and resiliently urged to the closed position.

Thereby, each flap door normally closes the upper end of the battery receiving portion defined in the corresponding inner case so that the battery receiving portion is protected from the intrusion of foreign matters, but swings open downward when the battery is pushed into the battery receiving portion.

Preferably, the battery case further comprising a top cover (2) that covers an upper end of the upper case in a liquid tight manner.

Thereby, the interior of the battery case can be effectively protected from the elements.

The present invention thus provides a battery case that can be freely positioned in a mobility device or the like without causing any undue effort on the part of the user who install and remove batteries into and out of the battery case.

### BRIEF DESCRIPTION OF THE DRAWING

FIG. 1 is a perspective view of a battery case according to an embodiment of the present invention;

FIG. 2 is a perspective view of the battery case with a top cover removed and batteries installed;

FIG. 3 is a view similar to FIG. 2 showing one of the batteries being moved out;

FIG. 4 is an exploded perspective view of the battery case;

FIG. 5 is a fragmentary sectional view taken along line V-V of FIG. 1;

FIG. 6 is a fragmentary sectional view taken along line VI-VI of FIG. 1;

FIG. 7 is an exploded perspective view showing a part of the upper case main body, and the associated flap door; and

FIG. 8 is perspective view of the battery case showing the path of water within the battery case.

FIG. 9 is a perspective view of a lock mechanism (fixing device) of the battery case;

FIG. 10 is a top view of the battery case with the top cover removed;

FIG. 11 is a sectional view taken along line XI-XI of FIG. 10;

FIG. 12 is a view similar to FIG. 11 with the top cover removed and the batteries installed;

FIG. 13 is an enlarged perspective view of the battery case as seen from above with the top cover removed;

FIG. 14 is a view similar to FIG. 11 showing a mode of operation of the battery case, and

FIG. 15 is a sectional view of the upper case taken along line XV-XV of FIG. 10.

### DESCRIPTION OF THE PREFERRED EMBODIMENT(S)

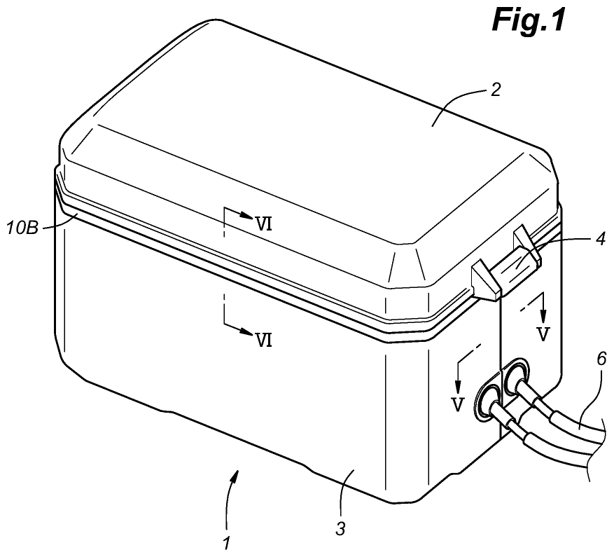

FIG. 1 shows a battery case 1 according to an embodiment of the present invention. This battery case 1 is for use in watercraft powered by an electric motor such as a boat. However, the present invention is applicable to any vehicles and devices that require a battery power source. The battery case 1 includes an outer case 3 having an open top end and a top cover 2 that removably covers the open top of the outer case 3. The battery case 1 has a generally rectangular box shape, and is elongated in one direction (which will be referred to as a longitudinal direction hereinafter). A lower part of a longitudinal end of the outer case 3 is provided with a pair of openings through which a pair of cables 6 extend via suitable grommets. For the convenience of description, the end from which the cables 6 extend will be referred to as a front end, and the other as a rear end. Further, the front end of the outer case 3 may be referred to as a prescribed side because water that may get into the battery case 1 is generally guided toward this side of the outer case 3 as will be discussed hereinafter.

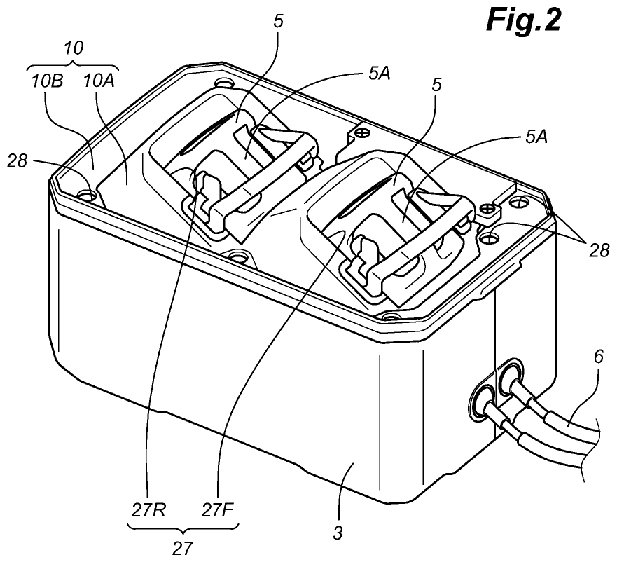

FIG. 2 shows a pair of batteries 5 placed in the battery case 1 with the top cover 2 removed. The batteries 5 consist of rechargeable batteries, and each have a rectangular box shape. The top end of each battery 5 is provided with a handle grip 5A. The two batteries 5 are positioned one behind the other in the longitudinal direction, and are slightly slanted when viewed from a side. In the illustrated embodiment, the batteries 5 are slanted forward (the upper end of each battery 5 is closer to the prescribed side of the outer case 3 than the lower end thereof). The bottom end of the outer case 3 is provided with a central opening defined by a flange provided along the lower edge of the side wall of the outer case 3 so as to project inward.

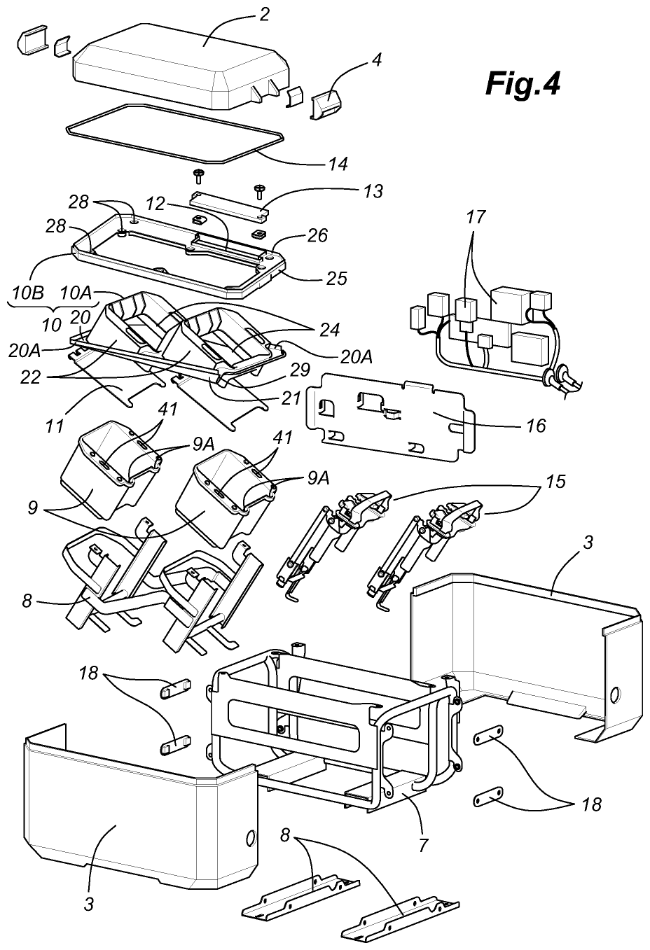

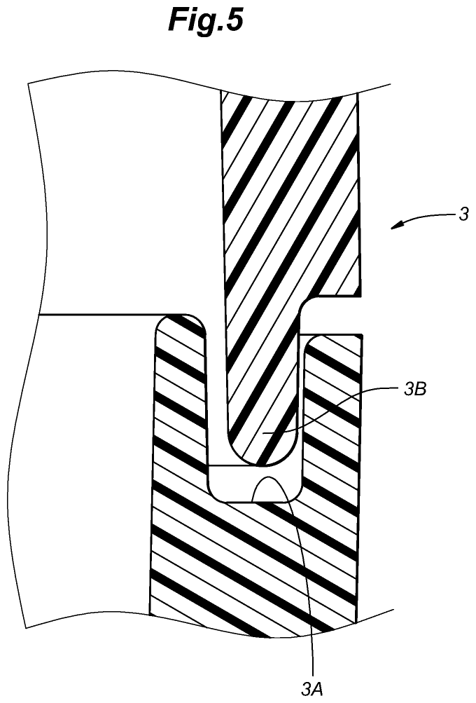

As best shown in FIG. 4, the outer case 3 consists of two halves which are joined by suitable connecting pieces 18 at a parting line extending in the longitudinal direction. FIG. 5 shows the junction between the two halves of the outer case 3. One of the halves is provided with a recess 3A, and the other half is provided with a projection 3B which protrudes into the recess 3A so that a labyrinth structure is formed between the two halves of the outer case 3, and intrusion of water from outside is suppressed. As shown in FIG. 4, an outer frame 7 made of metallic material is positioned inside the outer case 3, and is attached to the outer case 3 via fasteners not shown in the drawings. An inner frame 8 defining a pair of receiving spaces one behind the other therein is positioned inside the outer frame 7, and fixedly attached to the outer frame 7 by fasteners not shown in the drawings. The receiving spaces have open upper ends and are slanted forward in side view.

The receiving spaces defined by the inner frame 8 receive a pair of inner cases 9, respectively, each shaped as a box and having a substantially closed bottom and an open top. When the inner cases 9 are placed in the inner frame 8, the upper rear ends of the inner cases 9 stand proud of the upper edge of the outer case 3. The two corner parts of the front side of each inner case 9 are each provided with a trough 9A extending along the vertical length of the inner case 9. Owing to the forward slant of the inner case 9, the water that may get into the inner case 9 is guided into the troughs 9A owing to the forward slant of the inner case 9, and allowed to be expelled from the front side of the bottom end of the inner case 9.

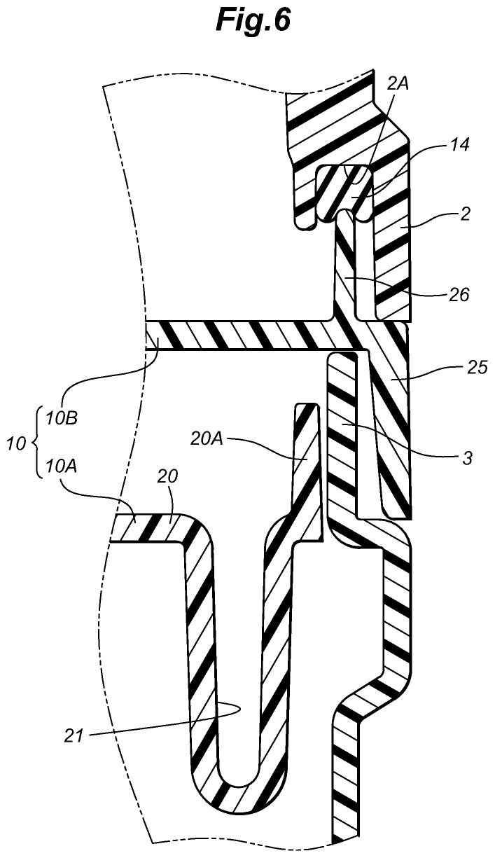

An upper case 10 is attached to the upper edge of the outer case 3. The upper case 10 consists of an upper case main body 10A and a peripheral cover 10B formed as two separate members. The upper case main body 10A includes shelf portion 20 having a generally rectangular shape, and extending substantially horizontally, a peripheral flange 20A projecting upward and extending along the inner surface of the upper edge of the outer case 3 on the four sides thereof, and a pair of troughs 21 extending along either side part of the shelf portion 20 immediately inward of the peripheral flange 20A. The upper case main body 10A further includes a pair of housing parts 22 each covering the upper edge of the corresponding inner case 9 along the both sides and rear side thereof, and a pair of rectangular upper openings 24 that align with the open tops of the inner case 9, respectively. As shown in FIG. 6, the peripheral flange 20A of the upper case main body 10A extends along and in close proximity of the inner surface of the upper edge of the side wall of the outer case 3.

As shown in FIGS. 4, 7, and 10, the rear edge of the upper opening 24 of each housing part 22 is fitted with a flap door 11 that normally closes the upper opening of the corresponding inner case 9 under the spring force of a spring member not shown in the drawings, and can be opened downward against the spring force when a battery 5 is pushed into the inner case 9. Each of the flap doors 11 normally closes the upper opening 24 of the battery receiving portion 27 defined in the corresponding inner case 9 and housing part 22 of the upper case 10 so that the battery receiving portion 27 is protected from the intrusion of foreign matters, but swings open downward without requiring any action by the user when the battery 5 is pushed into the battery receiving portion 27.

The peripheral cover 10B consists of a rectangular and annular member positioned on the upper edge of the side wall of the outer case 3 and the peripheral flange 20A of the upper case main body 10A. As shown in FIGS. 4 and 6, the peripheral cover 10B includes a depending flange 25 extending along the outer peripheral edge thereof, and an upright wall 26 extending along the outer peripheral edge thereof slightly inward of the depending flange 25. The depending flange 25 overlaps with the upper edge of the outer case 3 from outside. The housing parts 22 of the upper case 10 project upward through the central rectangular opening of the peripheral cover 10B.

As shown in FIG. 4, the peripheral cover 10B is provided with a rectangular opening 12 to allow access to a space defined between the corresponding side walls of the inner cases 9 and the opposing wall of the outer case 3. This space receives a support plate 16 which is secured to the inner cases 9. The support plate 16 supports various electrical components 17 associated with the batteries 5. This opening 12 is normally closed by a lid plate 13 which is secured by fasteners to the peripheral cover 10B.

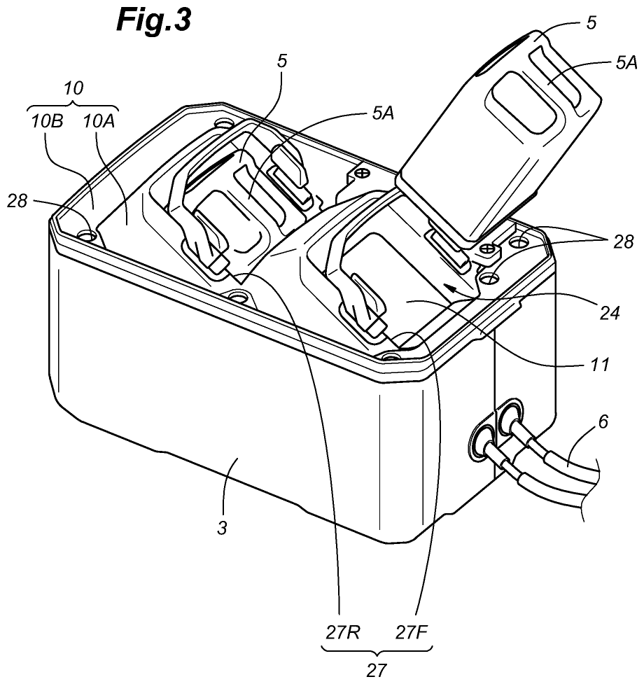

In this embodiment, the peripheral cover 10B has a horizontally extending, planar upper surface, but may also be slightly inclined such that an outer periphery thereof is slightly higher than an inner periphery thereof. As shown in FIGS. 2 to 4, the peripheral cover 10B is provided with a plurality of cylindrical recesses 28. The bottom of each cylindrical recess 28 is provided with an opening, and the upper case main body 10A is provided with a similar opening at a corresponding position thereof. A threaded bolt 30 is passed through each of the holes provided in the bottom of the cylindrical recesses 28, and the corresponding opening of the upper case main body 10A, and a nut 31 is threaded onto the threaded bolt 30 so that the upper case main body 10A and the peripheral cover 10B are joined to each other. Four of the threaded bolts 30 that are positioned adjacent to the four corners of the substantially rectangular opening defined on the inner periphery of the peripheral cover 10B are additionally passed through openings formed in the corresponding positions of the outer frame 7 with the result that the upper case main body 10A and the peripheral cover 10B are jointly fastened to the outer frame 7. A gap 35 is defined between the inner periphery of the peripheral cover 10B defining the central opening thereof and the opposing part of the upper case main body 10A. The water that is deposited on the upper surface of the peripheral cover 10B passes through this gap 35, and is received by the upper surface of the shelf portion 20 of the upper case main body 10A. The water is then guided to the trough 21.

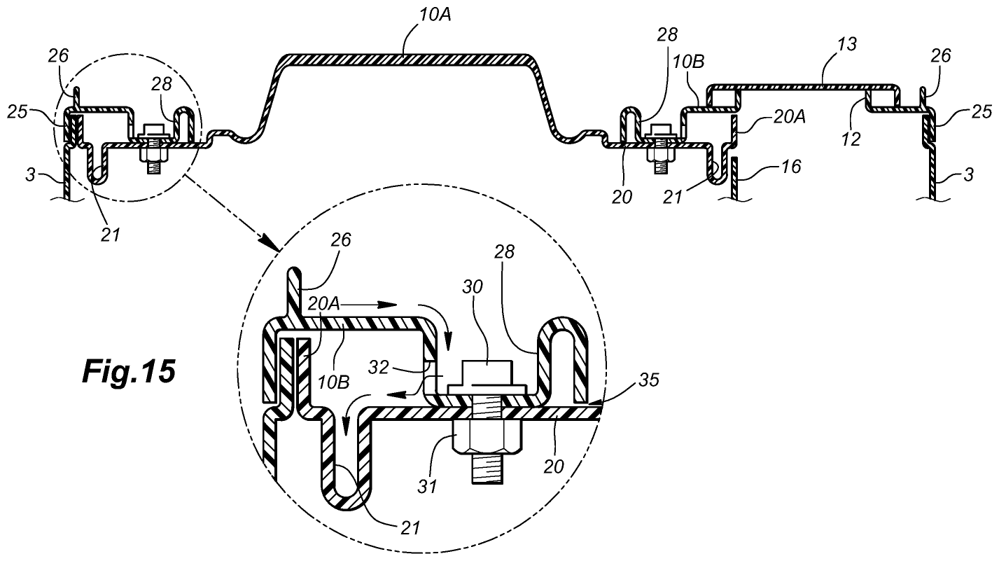

As best shown in FIG. 15, a lower end of the side wall of each cylindrical recess 28 is formed with a drain hole 32 so that the water that enters the cylindrical recess 28 is expelled to the upper surface of the shelf portion 20 of the upper case main body 10A via the drain hole 32, and eventually to the outside of the battery case 1 from the bottom part of the outer case 3 via the trough 21. In this embodiment, the water that is deposited on the upper surface of the peripheral cover 10B is expelled to the shelf portion 20 of the upper case main body 10A via both the gap 35 and the drain holes 32, but may also be via only one of them. Further, the peripheral cover 10B may be provided with drain holes that are positioned in places other than the cylindrical recesses 28.

As shown in FIGS. 1 and 6, the top cover 2 is configured to be placed on top of the peripheral cover 10B. The outer peripheral part of the top cover 2 is provided with a peripheral groove 2A which is recessed upward and fitted with an elastomeric seal member 14 therein. A pair of latches 4 are provided on the front and rear sides thereof to secure the top cover 2 to the peripheral cover 10B. When the top cover 2 is in place, the upright wall 26 of the peripheral cover 10B resiliently pushes against the elastomeric seal member 14 to ensure a liquid tight seal of the battery case 1.

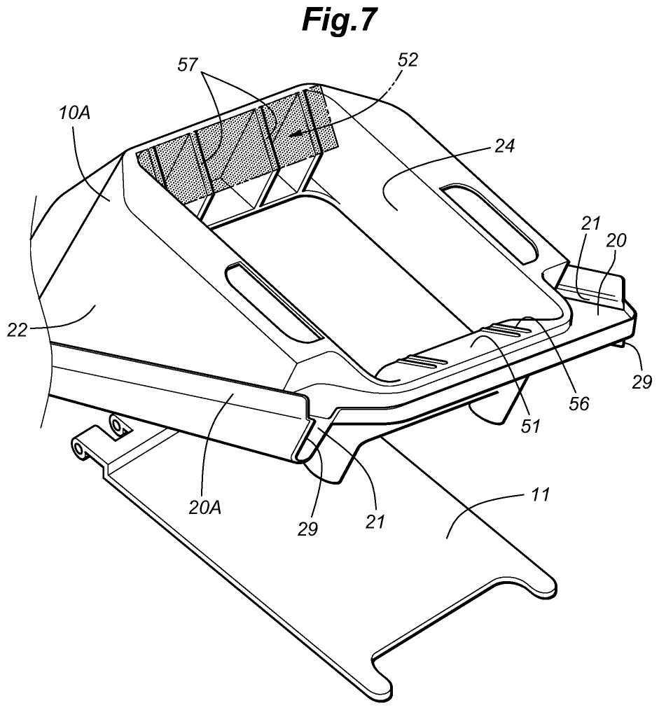

FIG. 7 shows a part of the upper case main body 10A in greater detail. The upper case 10 is provided with a pair of cutouts 29 at the two front corner parts of the upper case main body 10A (on the prescribed side of the outer case 3) so that water trapped in the troughs 21 is allowed to be expelled from the troughs 21 to an open part of the bottom end of the outer case 3 or a water guide (not shown in the drawings) that directs the water dropped thereon to the outside. To favorably guide the water in the troughs 21 toward the cutouts 29, the troughs 21 may have a bottom part that slants downward toward the cutouts 29.

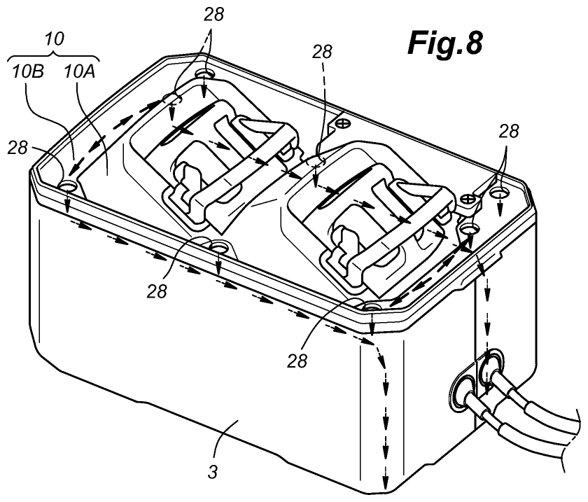

Thus, as shown in FIG. 8, when water seeps into the space defined between the top cover 2 and the upper case 10 or water falls onto the peripheral cover 10B (when the top cover 2 is removed), the water is drained downward onto the shelf portion 20 of upper case main body 10A mainly via the inner peripheral edge of the peripheral cover 10B and drops into the troughs 21 formed along the periphery of the upper case main body 10A, and falls downward from the cutouts 29 on the front corners thereof. Since the bottom end of the outer case 3 is open, the water is released from the bottom end of the outer case 3.

Thus, even if water should get into the battery case 1, the water can be readily removed from inside the battery case 1.

Also, when water falls onto the battery receiving portion 27 while the battery 5 is not installed, the flap door 11 prevents the water from reaching the bottom end of the battery receiving portion 27. Further, the troughs 9A provided on the front wall of the battery receiving portion 27 guide the water to the front side of the bottom end of the battery receiving portion 27 so as to be readily expelled therefrom without interfering with the electric connector 48.

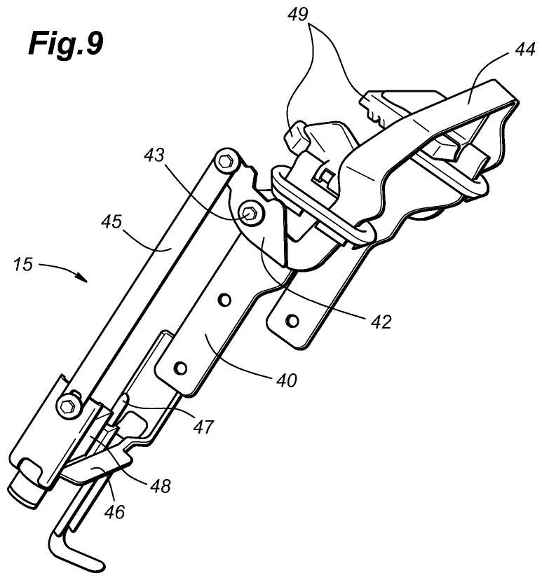

FIG. 9 shows a lock mechanism 15 provided for each inner case 9 to selectively retain a battery 5 in the inner case 9. The lock mechanism 15 includes a base frame 40 having a pair of legs extending into slots 41 (FIG. 4) formed in the flanges formed on either side of the upper end of the corresponding inner case 9. The legs of the base frame 40 are fixedly secured to the corresponding inner frame 8 by fasteners not shown in the drawings. A lever 42 extending substantially in the longitudinal direction is centrally pivoted to the base frame 40 via a pivot pin 43. An inverted-U shaped handle bar 44 is fixedly connected to one end of the levers 42. The other end of each lever 42 is connected to an upper end of a connecting piece 45 extending substantially vertically. The lower ends of the two connecting pieces 45 are connected to a stirrup member 46. The stirrup member 46 is provided with a pair of guide pins 47 and an electric connector 48 both facing substantially upward.

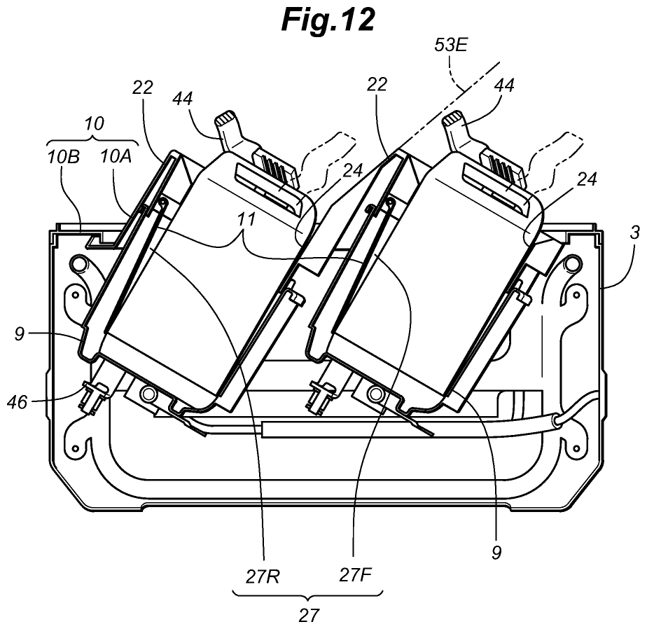

The handle bar 44 can be tilted between a lock position (position indicated by two-dot chain line in FIG. 12) and an unlock position (position indicated by solid line in FIG. 12). In the lock position, the handle bar 44 extends across the upper opening 24 of the upper case main body 10A, and the stirrup member 46 is raised from the bottom end of the inner case 9 via the lever 42 and the connecting piece 45. In the unlock position, the handle bar 44 is tilted rearward away from the upper opening 24 of the upper case main body 10A, and the stirrup member 46 is lowered to the bottom end of the inner case 9 via the lever 42 and the connecting piece 45.

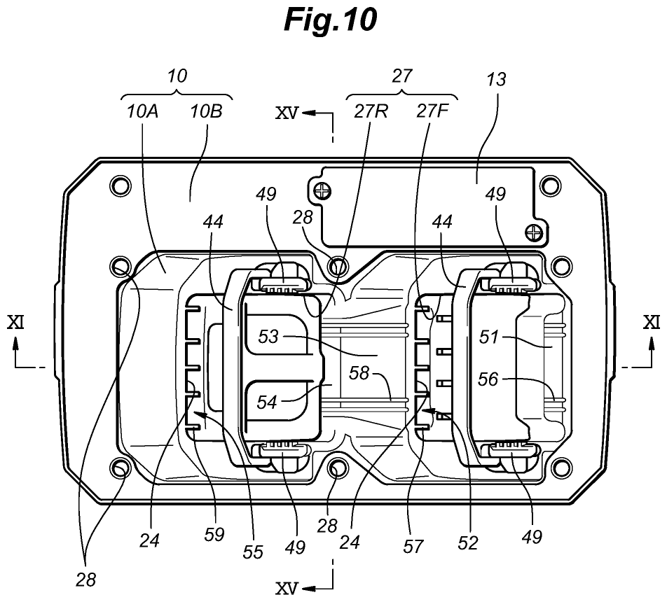

As shown in FIGS. 9 and 10, a pair of retaining members 49 are positioned on either side of each upper opening 24 of the upper case main body 10A so as to be pivotable about an axis extending the longitudinal direction along the side edges of the corresponding upper opening 24. These retaining members 49 are configured to mechanically cooperate with the base ends of the handle bar 44 so that the retaining members 49 press against the upper end of the battery 5 when the handle bar 44 is in the lock position and extends across the upper end of the battery 5, and are raised away from the top end of the battery 5 when the handle bar 44 is in the unlock position, and is raised away from the top end of the battery 5.

When placing the battery 5 in the inner case 9, the handle bar 44 is positioned in the unlock position. When the battery 5 is fully received in the inner case 9 at this time, the bottom end of the battery 5 is engaged by a stopper (not shown in the drawings) provided in the inner case 9, and is thereby spaced from the guide pins 47 and the electric connector 48. When the handle bar 44 is moved to the lock position at this time, the retaining members 49 are pushed against the top end of the battery 5 to hold the battery 5 in position. At the same time, the stirrup member 46 is lifted until the guide pins 47 are pushed into the corresponding guide holes provided in the bottom end of the battery 5, and the electric connector 48 is fully connected to the corresponding counterpart provided on the battery 5. Thus, by lowering the handle bar 44 from the unlock position to the lock position, the battery 5 is firmly retained, and the required electric connection between the battery 5 and the inner circuitry of the battery case 1 can be established. For more detailed structure of the lock mechanism 15, reference may be made to JP6891206B.

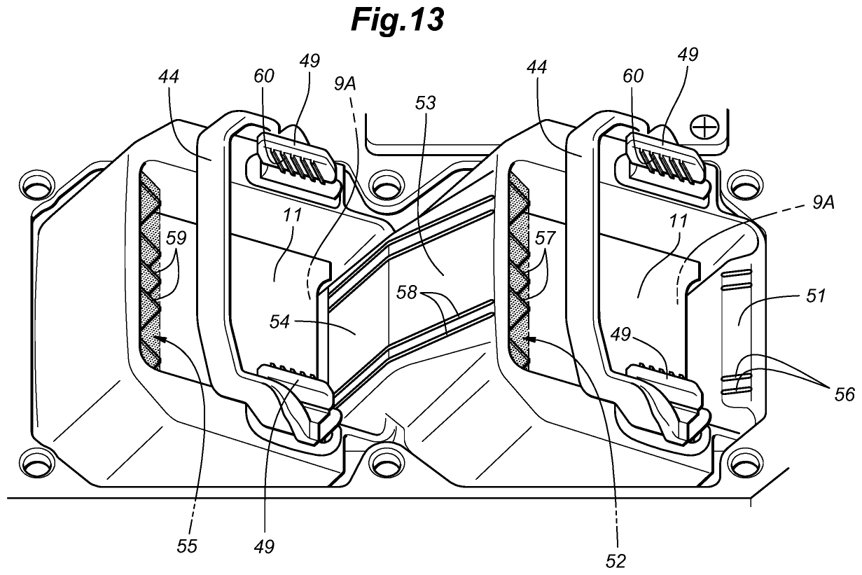

FIGS. 10 to 13 show the upper case main body 10A and the peripheral cover 10B in greater detail. The battery case 1 of the illustrated embodiment has two battery receiving portions 27 defined in the inner cases 9 one behind the other; the battery receiving portions 27 may thus be referred to as a front battery receiving portion 27F and a rear battery receiving portion 27R for the convenience of description.

The front and rear battery receiving portions 27F and 27R are configured to receive the batteries 5 in a forwardly tilted attitude. The front edge and the rear edge of the front battery receiving portion 27F are defined by parts of the upper case 10 which are flared as one moves upward in side view. The front edge of the front battery receiving portion 27F is defined by a first sloping surface 51 of the upper case main body 10A, and the rear edge of the front battery receiving portion 27F is defined by a second sloping surface 52 (see FIG. 7) of the upper case main body 10A. These first and second sloping surfaces 51 and 52 are provided with ribs 56 and 57 extending in the longitudinal direction.

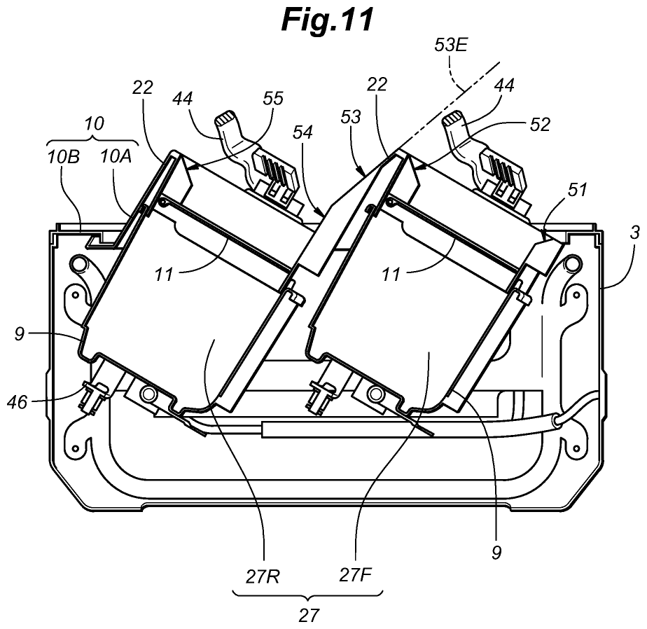

The front edge and the rear edge of the rear battery receiving portion 27R are defined by parts of the upper case 10 which are flared as one moves upward in side view similarly as in the case of the front battery receiving portion 27F. The front edge of the rear battery receiving portion 27R is defined by a third sloping surface 53 and a fourth sloping surface 54 of the upper case main body 10A which are positioned one after the other, the third sloping surface 53 being more remote from the rear battery receiving portion 27R than the fourth sloping surface 54. The third and fourth sloping surfaces 53 and 54 extend between the battery receiving portions 27 and slope downward from the front battery receiving portion 27F toward the rear battery receiving portion 27R. The third sloping surface 53 is more shallowly slanted than the fourth sloping surface 54. An extension 53E (see FIGS. 11 and 12) of the third sloping surface 53 which is shallowly slanted passes above the handle bar 44 for the front battery receiving portion 27F.

The third and fourth sloping surfaces 53 and 54 are provided with ribs 58 continuously extending in the longitudinal direction. The rear edge of the rear battery receiving portion 27R is defined by a fifth sloping surface 55 of the upper case main body 10A. The fifth sloping surface 55 is provided with ribs 59 extending in the longitudinal direction. The ribs 57 and 59 of the second sloping surface 52 and the fifth sloping surface 55 are taller than the ribs 56 and 58 of the first, third, and fourth sloping surfaces 51, 53, and 54 to provide a high mechanical stiffness and strength in the corresponding parts of the upper case 10. To be more exact, the second and the fifth sloping surfaces 52 and 55 may be considered as being defined by the free ends of the ribs 57 and 59. The same may be true with respect to the first, third, and fourth sloping surfaces 51, 53, and 54.

The ribs 56 and 58 provided on the first sloping surface 51 and the third and fourth sloping surfaces 53 and 54 are four in number in each case. The ribs 56 and 58 are positioned in a symmetric manner such that two of them (which are relatively closely positioned to each other) are located near one side of the sloping surfaces 51, 53, and 54 while the remaining two (which are also relatively closely positioned to each other) are located near the other side of the first, second, and third sloping surfaces 51, 53, and 54. Alternatively, only two ribs 56 and 58 may be positioned in each of the sloping surfaces 51, 53, and 54 such that the ribs are positioned near the laterally outer side of the sloping surface 51, 53, and 54 in a symmetric manner.

The side edges of the front and rear battery receiving portion 27 are fitted with side guide members provided with ribs 60 which for guiding the batteries 5 into and out of the respective battery receiving portions 27 in the lateral direction. The retaining members 49 positioned at the side edges of the front and rear battery receiving portions 27 are provided with ribs 60 and function as side guide members which for guiding the batteries 5 into and out of the respective battery receiving portions 27 in the lateral direction.

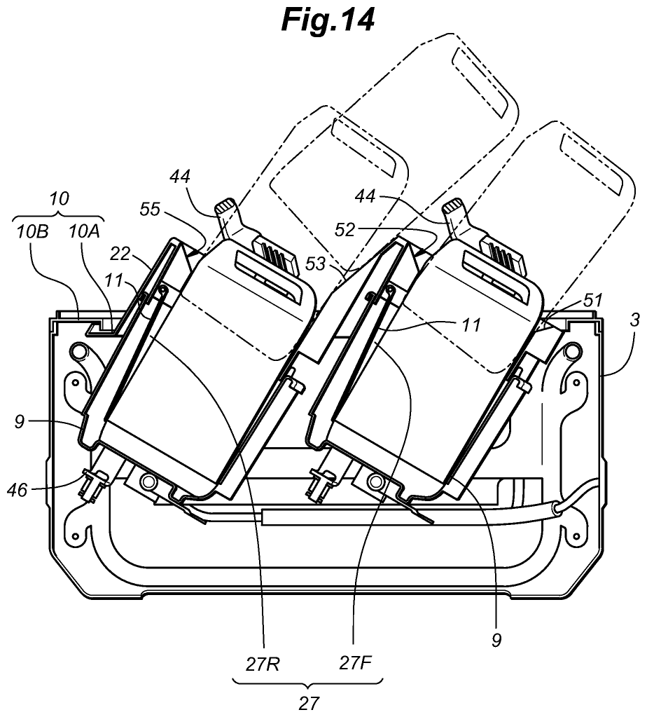

FIG. 14 shows the mode of operation of the battery case 1 of the illustrated embodiment. Typically, the user stands in front of the front end of the battery case 1. When placing the battery 5 into the front battery receiving portion, the user initially places the battery 5 on the first sloping surface 51. Then, the user lets the battery 5 slide into the front battery receiving portion 27F with the aid of the gravitational force until the battery 5 hits the bottom of the front battery receiving portion 27F. In case the user initially places the battery 5 in an excessively rearward position, the battery 5 may hit the second sloping surface 52, but owing to the inclination of the second sloping surface 52, the battery 5 is allowed to be pushed forward so as to be properly received in the front battery receiving portion 27F.

Even if the battery 5 is forcibly struck against the second sloping surface 52 during this process, owing to the tall ribs 57 provided on the second sloping surface 52, the upper case main body 10A, in particular the housing part 22 thereof is protected from any damage or deformation. The ribs 56 and 57 on the first sloping surface 51 and the second sloping surface 52 ensure a favorable guide action of these sloping surfaces 51 and 52 without involving any undue friction. Furthermore, the tilting of the front battery receiving portion 27F toward the user reduces the effort required for the user to place the battery 5 in the front battery receiving portion 27F.

When placing the battery 5 into the rear battery receiving portion 27R, extra effort may be required for the user because the rear battery receiving portion 27R is remote from the user as compared with the front battery receiving portion 27F. However, owing to the presence of the third sloping surface 53, the battery 5 may be allowed to rest upon a part of the upper case 10 located between the front battery receiving portion 27F and the rear battery receiving portion 27R without requiring any undue effort. This is particularly the case owing to the relatively shallow angle of the third sloping surface 53. As the battery 5 is pushed forward by the effort of the user and/or the gravitational force, the battery 5 which has been in a relatively tilted attitude gradually stands up, and slides along the third sloping surface 53 which is somewhat steeper than the second sloping surface 52. By this time, the gravitational force acting on the battery 5 is adequate to cause the battery 5 to be entirely received in the rear battery receiving portion 27R.

In this case also, even if the battery 5 is forcibly struck against the fifth sloping surface 55 during this process, owing to the tall ribs 59 provided on the fifth sloping surface 55, the upper case main body 10A, in particular the housing part 22 thereof, is protected from any damage or deformation. The ribs 58 on the third and fourth sloping surfaces 53 and 54 ensure a favorable guide action of these sloping surfaces 53 and 54 without involving any undue friction. Furthermore, the tilting of the rear battery receiving portion 27R (by the same angle as the front battery receiving portion 27F) toward the user reduces the effort required for the user to place the battery 5 in the rear battery receiving portion 27R.

According to the illustrated embodiment, since the batteries 5 are placed in the battery case 1 one behind the other, and are in a slanted attitude, not only the placing of the batteries 5 into and out of the battery case 1 is facilitated, but also the foot print of the battery case 1 can be minimized, and an increased freedom is provided in the positioning of the battery case 1 in the vehicle or the device which carries this battery case 1.

The present invention has been described in terms of a specific embodiment, but the present invention is not limited by such an embodiment and can be modified in various ways without departing from the scope of the present invention. For instance, the battery case 1 of the illustrated embodiment is designed to receive two batteries 5 one behind the other, but the present invention is equally applicable where three or more batteries 5 are arranged in a single row. Further, the batteries 5 may also be arranged in two or more rows.

Moreover, not all of the constituent elements shown in the above embodiments are essential to the broad concept of the present invention, and they can be appropriately selected, omitted and substituted without departing from the gist of the present invention. The contents of any cited references in this disclosure will be incorporated in the present application by reference.

1. A battery case, comprising:
a case assembly defining a front battery receiving portion and a rear battery receiving portion positioned one behind another in a longitudinal direction and each configured to receive a battery therein, each battery receiving portion having an upper opening for passing the battery into and out of the battery receiving portion; and
a fixing device configured to selectively retain the batteries in the respective battery receiving portions, the fixing device including blocking parts extending across upper ends of the batteries received in the respective battery receiving portions,
wherein the case assembly is provided with a sloping surface extending between the two battery receiving portions and sloping downward from the front battery receiving portion to the rear battery receiving portion, an extension of the sloping surface passing above the blocking part for the front battery receiving portion.

2. The battery case according to claim 1, wherein the sloping surface includes a front part and a rear part, the rear part being steeper than the front part in inclination.

3. The battery case according to claim 1, wherein the sloping surface is provided with a plurality of ribs extending in the longitudinal direction.

4. The battery case according to claim 1, wherein a part of the case assembly on a front edge of the front battery receiving portion is provided with an additional sloping surface sloping downward from a front part thereof to a rear part thereof.

5. The battery case according to claim 1, wherein a part of the case assembly on a rear edge of the rear battery receiving portion is provided with a yet additional sloping surface sloping upward from a front part thereof to a rear part thereof.

6. The battery case according to claim 5, wherein the yet additional sloping surface is provided with a plurality of ribs extending in the longitudinal direction.

7. The battery case according to claim 1, wherein the front and rear battery receiving portions are configured to receive the batteries in a forwardly tilted attitude.

8. The battery case according to claim 7, wherein a rear part of a bottom end of each battery receiving portion is fitted with an electric connector.

9. The battery case according to claim 1, wherein the blocking parts include a handle bar extending across an upper end of the battery received in each battery receiving portion.

10. The battery case according to claim 9, wherein the handle bar is configured to extend across the upper end of the battery in a lock position of the fixing device, and tilt upward away from the upper end of the battery in an unlock position of the fixing device.

11. The battery case according to claim 1, wherein the case assembly includes an outer case having an open top, a pair of inner cases having open tops and received in the outer case to define the front and rear battery receiving portions therein, respectively, and an upper case positioned on top of the inner cases and the outer case, and defining openings for providing access to the battery receiving portions.

12. The battery case according to claim 11, wherein the upper case includes an upper case main body and a peripheral cover that is positioned on top of a peripheral part of the upper case main body of the upper case, the upper case main body being provided with an opening to allow access into each inner case, the upper case main body being fitted with a flap door for each of the openings thereof which is pivotable between an upper closed position and a lower open position, and resiliently urged to the closed position.

13. The battery case according to claim 11, further comprising a top cover that covers an upper end of the upper case in a liquid tight manner.
